(19) United States
(12) Patent Application Publication
(10) Pub. No.: US 2023/0219390 A1
(43) Pub. Date: Jul. 13, 2023

(54) CONTROL ARM DEVICE AND AXLE SLEEVE ASSEMBLY OF DOUBLE A-ARM SUSPENSION SYSTEM

(71) Applicant: CCYS HI-TECH INTERNATIONAL LTD., TAICHUNG CITY (TW)

(72) Inventor: SHENG-YU WANG, TAICHUNG CITY (TW)

(73) Assignee: CCYS HI-TECH INTERNATIONAL LTD., TAICHUNG CITY (TW)

(21) Appl. No.: 18/094,689

(22) Filed: Jan. 9, 2023

(30) Foreign Application Priority Data
Jan. 11, 2022 (TW) 111200354

(51) Int. Cl. B60G 7/00; B60G 7/04

(52) U.S. Cl. CPC B60G 7/001; B60G 7/04

(57) ABSTRACT

An axle sleeve assembly includes a bushing with a first through hole, and an adjusting shaft jammed in the first through hole capably of being rotated by external force and having a second through hole whose central axis is parallel deviated from the central axis of the first through hole. A control arm device includes a control arm and two aforementioned axle sleeve assemblies. The control arm includes a front end portion for being installed with a joint, and two rear end portions each having an installation hole. The installation holes are coaxial with each other, and the bushings are disposed therein in a tight fit manner respectively. The axle sleeve assembly and the control arm device are applicable to an upper control arm of a double A-arm suspension system for adjusting the camber angle of a wheel, and have high structural strength.

### BACKGROUND OF THE INVENTION

### 1. Field of the Invention

The present invention relates generally to suspension systems of vehicles and more particularly, to a control arm device and an axle sleeve assembly of a double A-arm suspension system.

### 2. Description of the Related Art

It is well known that a suspension system is disposed on a chassis of a vehicle for absorbing the vibration and impact caused by the ground to the moving vehicle, thereby preventing components of the vehicle from damage and making people riding in the vehicle feel comfortable. The conventional suspension systems include a double A-arm suspension system, which is also called double-wishbone suspension. The double A-arm suspension system primarily includes a relatively small sized upper control arm, which is also called upper A-arm, a relatively large sized lower control arm, which is also called lower A-arm, a shock absorber disposed between the upper and lower control arms, and a linkage connected to front ends of the upper and lower control arms through connectors such as spherical universal joints respectively. Two rear ends of each of the upper and lower control arms are pivotably attached to the vehicle frame. Two ends of the shock absorber are pivotably attached to the vehicle frame and the lower control arm respectively. The linkage is connected with an installation disc. The installation disc is connected with a wheel.

After the installation or long-term use of the suspension system or the wheel, wheel alignment usually needs to be performed, including the adjustment of the camber angle of the wheel. The camber angle refers to the outward or inward inclined angle of the top end of the wheel with respect to the imaginary vertical line. Specifically speaking, if the camber angle is a positive number, it refers to the aforementioned outward inclined angle; if the camber angle is a negative number, it refers to the aforementioned inward inclined angle. As regards most of the conventional double A-arm suspension systems, the adjustment of the camber angle of the wheel is performed on the lower control arm, and the adjusting way thereof is quite complicated. The upper control arm adapted for the adjustment of the camber angle of the wheel is also commercially available. Such upper control arm is configured as an assembly of a plurality of components in a way that the junctures of the components are provided with elongated holes and bolts fastened therein. By adjusting the positions of the bolts relative to the elongated holes, the relative positions of the components are adjusted and thereby the length of the upper control arm is changed, so that the inclined angle of the aforementioned installation disc is changed and thus the camber angle of the wheel is adjusted. However, this adjusting way needs repeated detachment and attachment of the bolts, and the process is also quite complicated. Besides, the upper control arm is not made integrally as a one-piece member, but an assembly of a plurality of components, resulting in relatively low structural strength and doubts about loose bolts.

### SUMMARY OF THE INVENTION

The present invention has been accomplished in view of the above-noted circumstances. It is an objective of the present invention to provide an axle sleeve assembly and a control arm device including the aforementioned axle sleeve assembly, which are applicable to an upper control arm of a double A-arm suspension system and adapted for the adjustment of the camber angle of a wheel, and have high structural strength.

To attain the above objective, the present invention provides an axle sleeve assembly which includes a bushing and an adjusting shaft. The bushing is provided with a first through hole. The first through hole is defined with a first central axis. The adjusting shaft is jammed in the first through hole of the bushing in a way that the adjusting shaft is rotatable by an external force. The adjusting shaft is provided with a second through hole. The second through hole is defined with a second central axis. The second central axis is parallel deviated from the first central axis.

To attain the above objective, the present invention provides a control arm device of a double A-arm suspension system, which includes a control arm and two aforementioned axle sleeve assemblies. The control arm includes a front end portion for being installed with a joint, and two rear end portions each provided with an installation hole. The installation holes are coaxial with each other. The bushings of the axle sleeve assemblies are disposed in the installation holes of the control arm in a tight fit manner respectively.

As a result, the axle sleeve assembly of the present invention is applicable to an upper control arm of a double A-arm suspension system. In other words, the control arm in the control arm device of the present invention can be an upper control arm of a double A-arm suspension system. The second through hole of each axle sleeve assembly is configured for a pivoting axle to be inserted therethrough to make the control arm device pivotably attached to the chassis of the vehicle frame. When the camber angle of the wheel needs adjustment, the operator can use a tool to apply a certain external force to the adjusting shaft to rotate the adjusting shaft relative to the bushing and the control arm, so as to change the position of the front end portion of the control arm relative to the vehicle frame and thereby adjust the camber angle of the wheel. In the present invention, the function of adjusting the camber angle of the wheel is achieved by the axle sleeve assembly, so the control arm has no need to be a multi-member structure. In other words, the control arm can be made integrally as a one-piece member to have high structural strength.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is an assembled perspective view of a control arm device and a joint of a double A-arm suspension system according to a preferred embodiment of the present invention;

FIG. 2 is an exploded perspective view of the control arm device and the joint;

FIG. 3 is a top view of the control arm device;

FIG. 4 is a sectional view taken along the line 4-4 in FIG. 1;

FIG. 5 is a cutaway perspective view of a bushing of the control arm device;

FIG. 6A to FIG. 6C are side views of the control arm device and the joint, showing first to third positions of an adjusting shaft of the control arm device respectively; and

FIG. 7A to FIG. 7C are schematic views showing that the control arm device is applied in a double A-arm suspension system for adjusting the camber angle of a wheel.

### DETAILED DESCRIPTION OF THE INVENTION

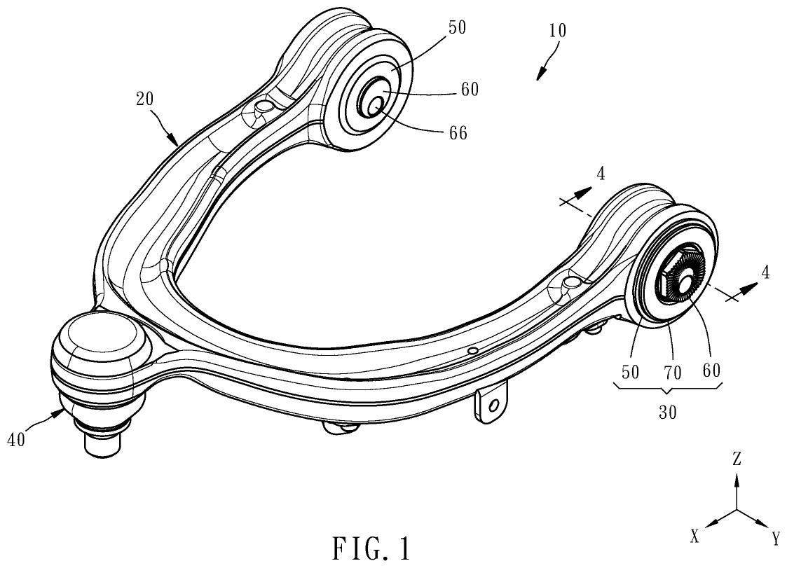

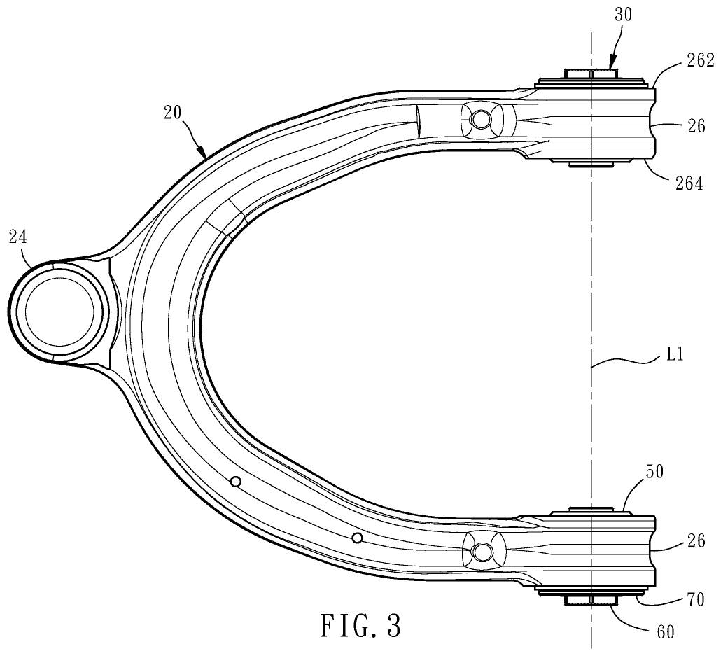

Referring to FIG. 1 to FIG. 3, a control arm device 10 of a double A-arm suspension system according to a preferred embodiment of the present invention includes a control arm 20, and two axle sleeve assemblies 30.

The control arm 20 is made of metal integrally, and approximately shaped as a wishbone. Specifically speaking, the control arm 20 in this embodiment includes a main body portion 22 approximately U-shaped on X-Y plane, a front end portion 24 extending from the central position of the main body portion 22 frontward (in the positive direction of X-axis), and two rear end portions 26 located at two terminal ends of the main body portion 22 respectively. The front end portion 24 is approximately shaped as a circular cap and configured for being installed with a joint 40. For example, the joint 40 in this embodiment is a spherical universal joint. Each rear end portion 26 is approximately shaped as a circular pipe disposed along Y-axis. Each rear end portion 26 has an outer surface 262, an inner surface 264, and an installation hole 266 penetrating through the outer surface 262 and the inner surface 264. The inner surfaces 264 of the two rear end portions 26 of the control arm 20 face each other, and the installation holes 266 are coaxial with each other. In other words, the central axes of the two installation holes 266 of the control arm 20 are collinear with each other.

Each axle sleeve assembly 30 includes a bushing 50, an adjusting shaft 60, and optionally a spacer 70.

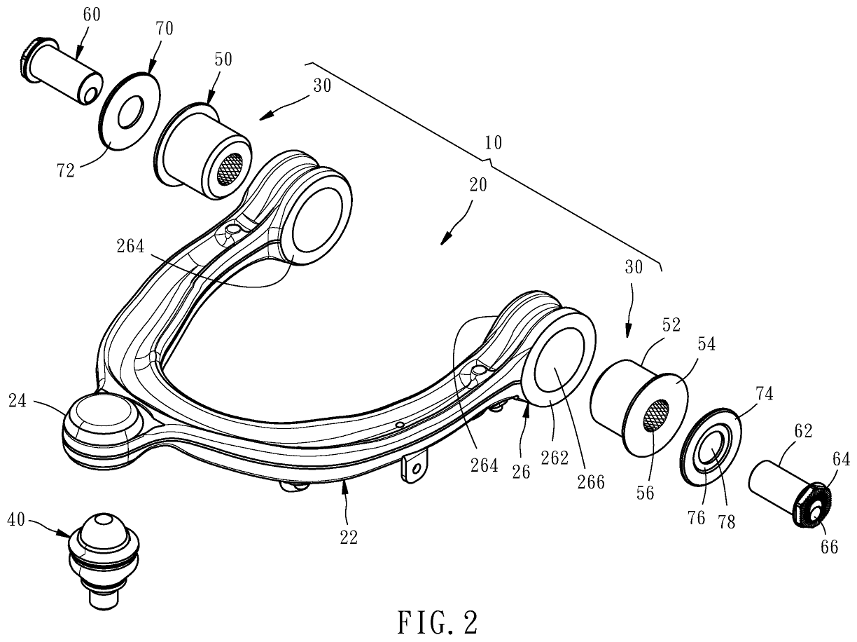

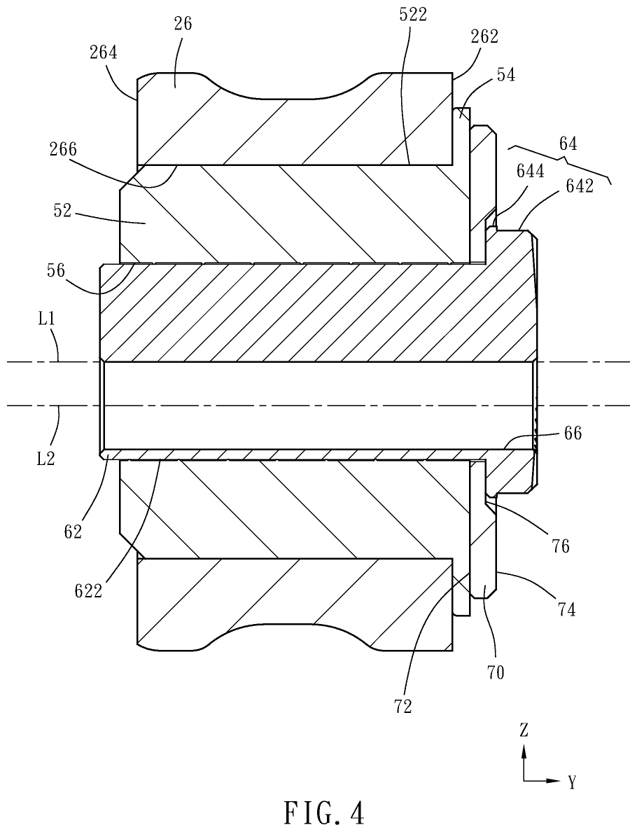

Referring to FIG. 2 and FIG. 4, the bushing 50 is integrally made of elastic material, such as rubber, TPU (thermoplastic polyurethane) and so on, and includes a cylinder-shaped body portion 52 and a stopping portion 54 located at an end of the body portion 52 and shaped as a circular plate. The stopping portion 54 protrudes out of the outer peripheral surface 522 of the body portion 52. Besides, the bushing 50 is provided with a first through hole 56. The first through hole 56 penetrates through the center of the stopping portion 54 and the center of the body portion 52, and is defined with a first central axis L1. In other words, the central axis of the bushing 50 is the first central axis L1.

The adjusting shaft 60 is integrally made of metal, and includes a cylinder-shaped rod portion 62 and a head portion 64 located at an end of the rod portion 62. The head portion 64 protrudes out of the outer peripheral surface 622 of the rod portion 62. The head portion 64 includes a hexagonal section 642 and a circular section 644 located between the hexagonal section 642 and the rod portion 62. Besides, the adjusting shaft 60 is provided with a second through hole 66. The second through hole 66 penetrates through the head portion 64 and the rod portion 62 eccentrically, and is defined with a second central axis L2. In other words, the central axis of the adjusting shaft 60 is not collinear with the second central axis L2.

The axle sleeve assemblies 30 are respectively installed into the installation holes 266 of the control arm 20 from the outer surface to the inner surface. The body portions 52 of the bushings 50 are disposed in the installation holes 266 of the control arm 20 in a tight fit manner. The stopping portions 54 of the bushings 50 are abutted against the outer surfaces 262 of the rear end portions 26 respectively. The adjusting shafts 60 are jammed in the first through holes 56 of the bushings 50 in a way that the adjusting shafts 60 are rotatable by external force, the detail of which will be given hereinafter. At this time, the central axes of the installation holes 266 of the control arm 20 and the central axes of the adjusting shafts 60 are all collinear with the central axis of the bushings 50, i.e. the first central axis L1. The central axis of the second through hole 66 of each adjusting shaft 60, i.e. the second central axis L2, is parallel deviated from the first central axis L1. In other words, the first and second central axes L1 and L2 are both parallel to Y-axis, but not collinear with each other.

In this embodiment, a spacer 70 is further provided between the stopping portion 54 of the bushing 50 and the head portion 64 of the adjusting shaft 60. The spacer 70 has an inner surface 72 attached to the stopping portion 54 of the bushing 50, an outer surface 74 opposite to the inner surface 72, a recess 76 recessed from the outer surface 74, and a third through hole 78 penetrating through the spacer 70 and located at the center of the recess 76. The rod portion 62 of the adjusting shaft 60 is firstly inserted through the third through hole 78 of the spacer 70, and then inserted through the first through hole 56 of the bushing 50. The circular section 644 of the head portion 64 of the adjusting shaft 60 is disposed in the recess 76 and abutted against the spacer 70. That is beneficial for the connection of the bushing 50 and the adjusting shaft 60, and beneficial for the rotation of the adjusting shaft 60 to be specified hereinafter. However, the axle sleeve assembly 30 of present invention may include no such spacer 70.

It can be known from the above description that after the axle sleeve assembly 30 is installed in the installation hole 266 of the control arm 20, the bushing 50 is fixed to the control arm 20. When it is mentioned in the present invention that the adjusting shaft 60 is jammed in the first through hole 56 of the bushing 50 in a way that the adjusting shaft 60 is rotatable by an external force, it means the adjusting shaft 60 is rotatable by a great external force, but except that, the adjusting shaft 60 in the normal condition is fixed relative to the bushing 50 and the control arm 20. For example, the adjusting shaft 60 in this embodiment is configured for the operator to use a hexagonal wrench to apply force to the hexagonal section 642 of the head portion 64 to rotate the adjusting shaft 60 relative to the bushing 50 and the control arm 20.

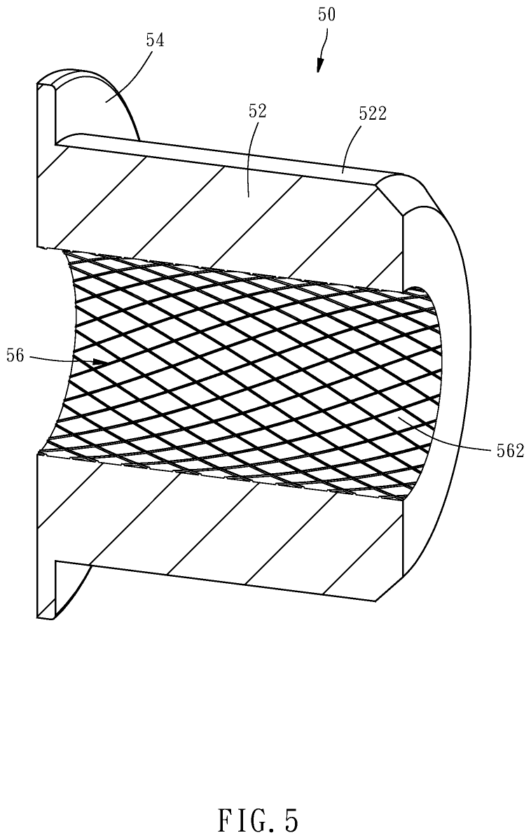

Further speaking, referring to FIG. 5, the first through hole 56 of the bushing 50 in this embodiment has a rough inner wall 562. The rough inner wall 562 may, but unlimited to, be formed by texturing, and thus the rough inner wall 562 has a concave and convex configuration. For example, the rough inner wall 562 in this embodiment has slightly protruding mesh texture. The above-described features are all beneficial for the adjusting shaft 60 to be stably fixed relative to the bushing 50 in the normal condition. After being formed, the rough inner wall 562 may, but unlimited to, be further processed by immersion lubrication, which is beneficial for the adjusting shaft 60 to be rotated relative to the bushing 50 by an intended external force.

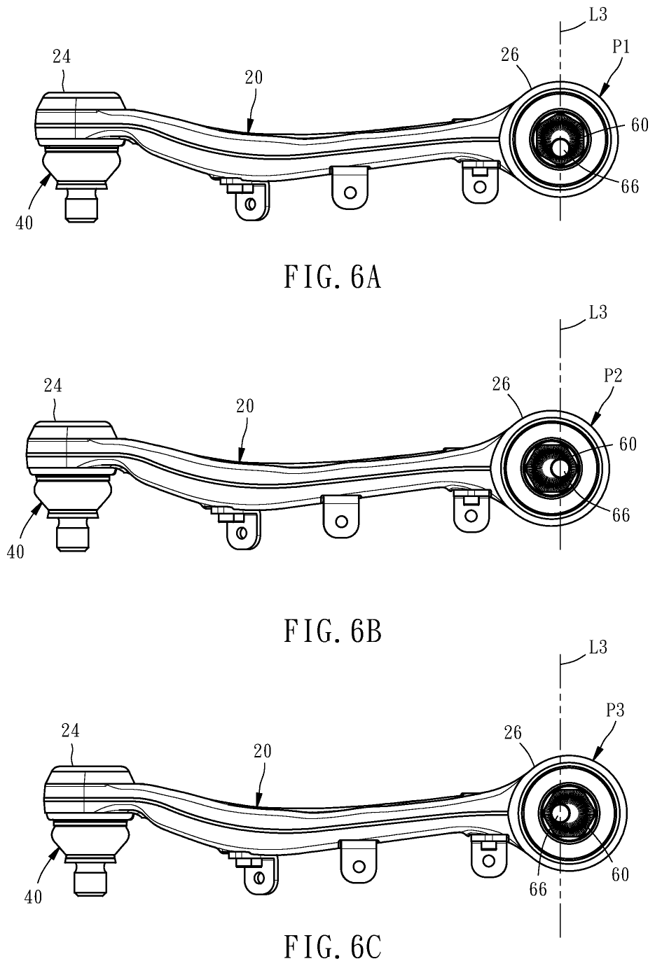

Because the second central axis L2 of the second through hole 66 of the adjusting shaft 60 is deviated from the first central axis L1 of the first through hole 56 of the bushing 50 and the position of the first through hole 56 of the bushing 50 relative to the front end portion 24 of the control arm 20 is invariable, when the adjusting shaft 60 is rotated by the external force, the position of the second through hole 66 thereof relative to the front end portion 24 of the control arm 20 is changed. For example, when the adjusting shaft 60 is rotated from a first position P1 as shown in FIG. 6A to a second position P2 as shown in FIG. 6B, the X-axial distance between the center of the second through hole 66 and the front end portion 24 of the control arm 20 is increased. When the adjusting shaft 60 is rotated from the first position P1 as shown in FIG. 6A to a third position P3 as shown in FIG. 6C, the X-axial distance between the center of the second through hole 66 and the front end portion 24 of the control arm 20 is decreased. The adjusting shafts 60 of the control arm device 10 are configured for pivoting axles (not shown) to be inserted through the second through holes 66 respectively and thereby pivotably attached to the vehicle frame. In FIG. 6A to FIG. 6C, the vehicle frame is represented by an imaginary reference line L3. In other words, the position of the second through hole 66 of the adjusting shaft 60 relative to the vehicle frame is invariable, so the position of the front end portion 24 of the control arm 20 relative to the vehicle frame is changed along with the rotation of the adjusting shaft 60 by the external force.

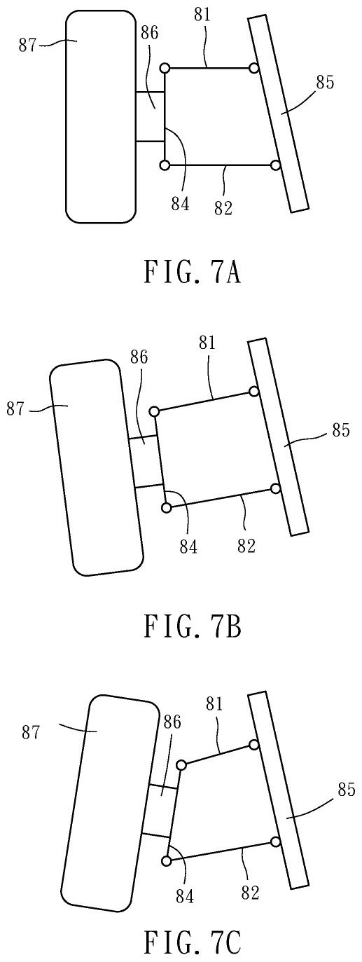

Referring to FIG. 7A to FIG. 7C, FIG. 7A to FIG. 7C are linkage mechanism sketches schematically showing an upper control arm 81, a lower control arm 82 and a linkage 84 of a double A-arm suspension system, wherein the linkage 84 is connected to the front ends of the upper and lower control arms 81 and 82 by connectors such as universal joints. In FIG. 7A to FIG. 7C, a vehicle frame 85, an installation disc 86 connected with the linkage 84 and a wheel 87 connected with the installation disc 86 are also schematically shown, and two rear ends of each of the upper and lower control arms 81 and 82 are pivotably attached to the vehicle frame 85. The control arm device 10 of the present invention is applicable to the upper control arm of the double A-arm suspension system. In other words, the control arm 20 in the present invention can serve as the upper control arm 81 as shown in FIG. 7A to FIG. 7C, and the joint 40 is the connector connecting the upper control arm 81 with the linkage 84. When the X-axial distance between the center of the second through hole 66 and the front end portion 24 of the control arm 20 is increased by the rotation of the adjusting shaft 60 as described above, such as the change from the condition shown in FIG. 7A to the condition shown in FIG. 7B, the length of the upper control arm 81 is increased, making the upper end of the linkage 84 moved toward the wheel 87 to adjust the camber angle of the wheel 87 outwardly through the installation disc 86. When the X-axial distance between the center of the second through hole 66 and the front end portion 24 of the control arm 20 is decreased by the rotation of the adjusting shaft 60 as described above, such as the change from the condition shown in FIG. 7A to the condition shown in FIG. 7C, the length of the upper control arm 81 is decreased, making the upper end of the linkage 84 moved toward the vehicle frame 85 to adjust the camber angle of the wheel 87 inwardly through the installation disc 86.

As a result, when the camber angle of the wheel needs adjustment, the operator can use a tool to apply certain external force to the adjusting shaft 60 to rotate the adjusting shaft 60 relative to the bushing 50 and the control arm 20, so as to change the position of the front end portion 24 of the control arm 20 relative to the vehicle frame and thus adjust the camber angle of the wheel. This adjusting manner is relatively simple and convenient. Besides, the control arm 20 in the present invention has no need to be a multi-member structure. In other words, the control arm 20 can be made integrally as a one-piece member to have high structural strength.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A control arm device of a double A-arm suspension system, the control arm device comprising:
a control arm comprising a front end portion for being installed with a joint, and two rear end portions each provided with an installation hole, the installation holes of the two rear end portions being coaxial with each other; and
two axle sleeve assemblies disposed in the installation holes of the control arm respectively, each of the axle sleeve assemblies comprising a bushing and an adjusting shaft, the bushing being disposed in the installation hole of the control arm in a tight fit manner, the bushing being provided with a first through hole, the first through hole being defined with a first central axis, the adjusting shaft being jammed in the first through hole of the bushing in a way that the adjusting shaft is rotatable by an external force, the adjusting shaft being provided with a second through hole, the second through hole being defined with a second central axis, the second central axis being parallel deviated from the first central axis.

2. The control arm device as claimed in claim 1, wherein the first through hole of the bushing has a rough inner wall.

3. The control arm device as claimed in claim 2, wherein the rough inner wall is formed by texturing.

4. The control arm device as claimed in claim 2, wherein the rough inner wall is processed by immersion lubrication.

5. The control arm device as claimed in claim 2, wherein the rough inner wall is formed by texturing; the rough inner wall is processed by immersion lubrication; the rough inner wall has mesh texture.

6. The control arm device as claimed in claim 5, wherein the adjusting shaft comprises a rod portion and a head portion located at an end of the rod portion; the head portion protrudes out of an outer peripheral surface of the rod portion; the rod portion is inserted in the first through hole of the bushing; the head portion is located out of the first through hole and at least partially hexagon-shaped; the bushing comprises a body portion and a stopping portion located at an end of the body portion; the stopping portion protrudes out of an outer peripheral surface of the body portion; the body portion is inserted in the installation hole of the control arm; the stopping portion is abutted against a surface of the rear end portion of the control arm; the axle sleeve assembly further comprises a spacer; the spacer is disposed between the stopping portion of the bushing and the head portion of the adjusting shaft; the spacer has an inner surface attached to the stopping portion of the bushing, an outer surface opposite to the inner surface, a recess recessed from the outer surface, and a third through hole located in the recess; the rod portion of the adjusting shaft is inserted through the third through hole; the head portion of the adjusting shaft is partially located in the recess.

7. The control arm device as claimed in claim 2, wherein the rough inner wall has mesh texture.

8. The control arm device as claimed in claim 1, wherein the adjusting shaft comprises a rod portion and a head portion located at an end of the rod portion; the head portion protrudes out of an outer peripheral surface of the rod portion; the rod portion is inserted in the first through hole of the bushing; the head portion is located out of the first through hole and at least partially hexagon-shaped.

9. The control arm device as claimed in claim 8, wherein the bushing comprises a body portion and a stopping portion located at an end of the body portion; the stopping portion protrudes out of an outer peripheral surface of the body portion; the body portion is inserted in the installation hole of the control arm; the stopping portion is abutted against a surface of the rear end portion of the control arm; the axle sleeve assembly further comprises a spacer; the spacer is disposed between the stopping portion of the bushing and the head portion of the adjusting shaft.

10. The control arm device as claimed in claim 9, wherein the spacer has an inner surface attached to the stopping portion of the bushing, an outer surface opposite to the inner surface, a recess recessed from the outer surface, and a third through hole located in the recess; the rod portion of the adjusting shaft is inserted through the third through hole; the head portion of the adjusting shaft is partially located in the recess.

11. An axle sleeve assembly, which is configured to be disposed in an installation hole of a control arm of a double A-arm suspension system, the axle sleeve assembly comprising:
a bushing configured to be disposed in the installation hole of the control arm in a tight fit manner, the bushing being provided with a first through hole, the first through hole being defined with a first central axis; and
an adjusting shaft jammed in the first through hole of the bushing in a way that the adjusting shaft is rotatable by an external force, the adjusting shaft being provided with a second through hole, the second through hole being defined with a second central axis, the second central axis being parallel deviated from the first central axis.

12. The axle sleeve assembly as claimed in claim 11, wherein the first through hole of the bushing has a rough inner wall.

13. The axle sleeve assembly as claimed in claim 12, wherein the rough inner wall is formed by texturing.

14. The axle sleeve assembly as claimed in claim 12, wherein the rough inner wall is processed by immersion lubrication.

15. The axle sleeve assembly as claimed in claim 12, wherein the rough inner wall is formed by texturing; the rough inner wall is processed by immersion lubrication;
the rough inner wall has mesh texture.

16. The axle sleeve assembly as claimed in claim 15, wherein the adjusting shaft comprises a rod portion and a head portion located at an end of the rod portion; the head portion protrudes out of an outer peripheral surface of the rod portion; the rod portion is inserted in the first through hole of the bushing; the head portion is located out of the first through hole and at least partially hexagon-shaped; the bushing comprises a body portion and a stopping portion located at an end of the body portion; the stopping portion protrudes out of an outer peripheral surface of the body portion; the axle sleeve assembly further comprises a spacer; the spacer is disposed between the stopping portion of the bushing and the head portion of the adjusting shaft; the spacer has an inner surface attached to the stopping portion of the bushing, an outer surface opposite to the inner surface, a recess recessed from the outer surface, and a third through hole located in the recess; the rod portion of the adjusting shaft is inserted through the third through hole;
the head portion of the adjusting shaft is partially located in the recess.

17. The axle sleeve assembly as claimed in claim 12, wherein the rough inner wall has mesh texture.

18. The axle sleeve assembly as claimed in claim 11, wherein the adjusting shaft comprises a rod portion and a head portion located at an end of the rod portion; the head portion protrudes out of an outer peripheral surface of the rod portion; the rod portion is inserted in the first through hole of the bushing; the head portion is located out of the first through hole and at least partially hexagon-shaped.

19. The axle sleeve assembly as claimed in claim 18, wherein the bushing comprises a body portion and a stopping portion located at an end of the body portion;
the stopping portion protrudes out of an outer peripheral surface of the body portion; the axle sleeve assembly further comprises a spacer; the spacer is disposed between the stopping portion of the bushing and the head portion of the adjusting shaft.

20. The axle sleeve assembly as claimed in claim 19, wherein the spacer has an inner surface attached to the stopping portion of the bushing, an outer surface opposite to the inner surface, a recess recessed from the outer surface, and a third through hole located in the recess; the rod portion of the adjusting shaft is inserted through the third through hole; the head portion of the adjusting shaft is partially located in the recess.
